(19) United States
(12) Patent Application Publication
(10) Pub. No.: US 2005/0175235 A1
(43) Pub. Date: Aug. 11, 2005

(54) Method and apparatus for selectively extracting training data for a pattern recognition classifier using grid generation

(75) Inventors: Yun Luo, Livonia, MI (US); Jon K. Wallace, Redford, MI (US); Farid Khairallah, Farmington Hills, MI (US); Robert Dziadula, Farmington Hills, MI (US); Russell J. Lynch, West Bloomfield, MI (US)

Correspondence Address: TAROLLI, SUNDHEIM, COVELL & TUMMINO L.L.P., 526 SUPERIOR AVENUE, SUITE 1111, CLEVELAND, OH, 44114-1400, US

(73) Assignee: TRW Automotive U.S. LLC

(21) Appl. No.: 10/772,655

(22) Filed: Feb. 5, 2004

(51) Int. Cl. G06K 9/62; G06K 9/46

(52) U.S. Cl. 382/159; 382/190

(57) ABSTRACT

A system (600) for selectively generating training data for a pattern recognition classifier includes an image synthesizer (606) that combines a plurality of training images from an output class into a class composite image. A grid generator (608) generates a grid pattern representing the output class from the class composite image. A feature extractor (610) extracts feature data from the plurality of training images according to the generated grid pattern.

### TECHNICAL FIELD

The present invention is directed generally to pattern recognition classifiers and is particularly directed to a method and apparatus for selectively extracting image data for a pattern recognition classifier according to determined features of an output class that is particularly useful in occupant restraint systems for object and/or occupant classification.

### BACKGROUND OF THE INVENTION

Actuatable occupant restraining systems having an inflatable air bag in vehicles are known in the art. Such systems that are controlled in response to whether the seat is occupied, an object on the seat is animate or inanimate, a rearward facing child seat present on the seat, and/or in response to the occupant's position, weight, size, etc., are referred to as smart restraining systems. One example of a smart actuatable restraining system is disclosed in U.S. Pat. No. 5,330,226.

Pattern recognition systems can be loosely defined as systems capable of distinguishing between classes of real world stimuli according to a plurality of distinguishing characteristics, or features, associated with the classes. A number of pattern recognition systems are known in the art, including various neural network classifiers, self-organizing maps, and Bayesian classification models. A common type of pattern recognition system is the support vector machine, described in modern form by Vladimir Vapnik [C. Cortes and V. Vapnik, “Support Vector Networks,” Machine Learning, Vol. 20, pp. 273-97, 1995].

Support vector machines are intelligent systems that generate appropriate separating functions for a plurality of output classes from a set of training data. The separating functions divide an N-dimensional feature space into portions associated with the respective output classes, where each dimension is defined by a feature used for classification. Once the separators have been established, future input to the system can be classified according to its location in feature space (e.g., its value for N features) relative to the separators. In its simplest form, a support vector machine distinguishes between two output classes, a “positive” class and a “negative” class, with the feature space segmented by the separators into regions representing the two alternatives.

### SUMMARY OF THE INVENTION

In accordance with one exemplary embodiment of the present invention, a system for selectively generating training data for a pattern recognition classifier associated with a vehicle occupant safety system includes a vision system that images the interior of a vehicle. The vision system provides a plurality of training images representing an output class. A grid generator generates a grid pattern representing the output class from a class composite image. A feature extractor extracts training data from the plurality of training images according to the generated grid pattern.

In accordance with another exemplary embodiment of the present invention, a system for selectively generating training data for a pattern recognition classifier includes an image synthesizer that combines a plurality of training images from an output class into a class composite image. A grid generator generates a grid pattern representing the output class from the class composite image. A feature extractor extracts feature data from the plurality of training images according to the generated grid pattern.

In accordance with yet another exemplary embodiment of the present invention, a method is provided for selectively generating training data for a pattern recognition classifier from a plurality of training images representing a desired output class. A representative image is generated that represents the output class. The representative image is divided according to an initial grid pattern to form a plurality of sub-images. Sub-images formed by the grid pattern are identified as having at least one attribute of interest. The grid pattern is modified in response to the identified sub-image having the at least one attribute of interest so as to form a modified grid. The modified grid pattern is used to extract respective feature vectors from the plurality of training images.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of an actuatable restraining system in accordance with an exemplary embodiment of the present invention;

FIG. 2 is a schematic illustration of a stereo camera arrangement for use with the present invention for determining location of an occupant's head;

FIG. 3 is a flow chart showing a training process in accordance with an exemplary embodiment of the present invention;

FIG. 4 is a flow chart showing a grid generation algorithm in accordance with an exemplary embodiment of the present invention;

FIGS. 5A-5D provide a schematic illustration of an imaged shape example subjected to an exemplary grid generation algorithm in accordance with an exemplary embodiment of the present invention; and

FIG. 6 is a diagram illustrating a classifier training system in accordance with an exemplary embodiment of the present invention.

### DESCRIPTION OF PREFERRED EMBODIMENT

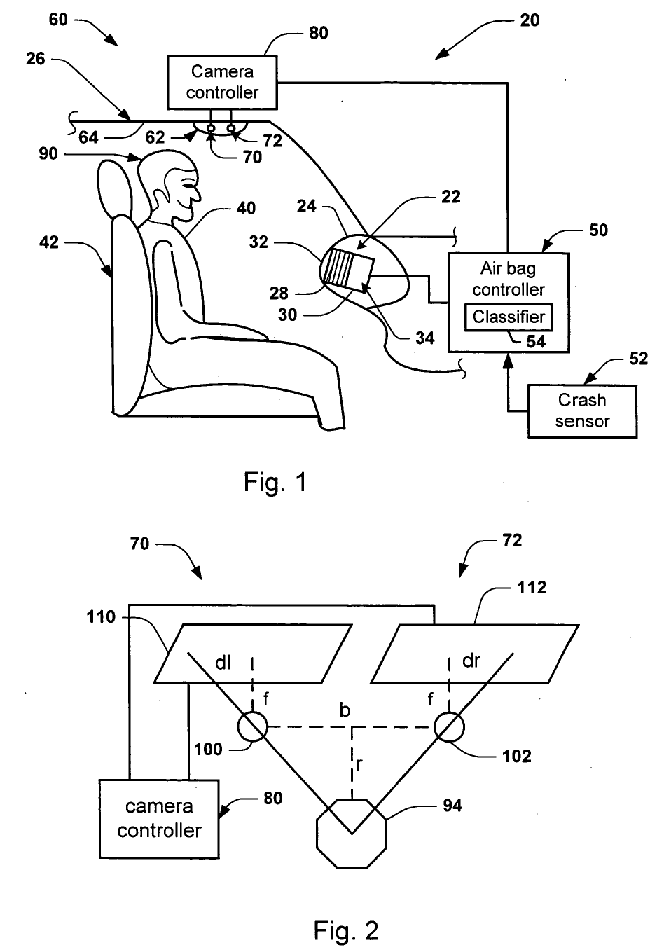

Referring to FIG. 1, an exemplary embodiment of an actuatable occupant restraint system 20, in accordance with the present invention, includes an air bag assembly 22 mounted in an opening of a dashboard or instrument panel 24 of a vehicle 26. The air bag assembly 22 includes an air bag 28 folded and stored within the interior of an air bag housing 30. A cover 32 covers the stored air bag and is adapted to open easily upon inflation of the air bag 28.

The air bag assembly 22 further includes a gas control portion 34 that is operatively coupled to the air bag 28. The gas control portion 34 may include a plurality of gas sources (not shown) and vent valves (not shown) for, when individually controlled, controlling the air bag inflation, e.g., timing, gas flow, bag profile as a function of time, gas pressure, etc. Once inflated, the air bag 28 helps protect an occupant 40, such as a vehicle passenger, sitting on a vehicle seat 42. Although the embodiment of FIG. 1 is described with regard to a vehicle passenger seat, it is applicable to a vehicle driver seat and back seats and their associated actuatable restraining systems. The present invention is also applicable to the control of side actuatable restraining devices.

An air bag controller 50 is operatively connected to the air bag assembly 22 to control the gas control portion 34 and, in turn, inflation of the air bag 28. The air bag controller 50 can take any of several forms such as a microcomputer, discrete circuitry, an application-specific-integrated-circuit (“ASIC”), etc. The controller 50 is further connected to a vehicle crash sensor 52, such as one or more vehicle crash accelerometers. The controller monitors the output signal(s) from the crash sensor 52 and, in accordance with an air bag control algorithm using a crash analysis algorithm, determines if a deployment crash event is occurring, i.e., one for which it may be desirable to deploy the air bag 28. There are several known deployment crash analysis algorithms responsive to crash acceleration signal(s) that may be used as part of the present invention. Once the controller 50 determines that a deployment vehicle crash event is occurring using a selected crash analysis algorithm, and if certain other occupant characteristic conditions are satisfied, the controller 50 controls inflation of the air bag 28 using the gas control portion 34, e.g., timing, gas flow rate, gas pressure, bag profile as a function of time, etc.

The air bag restraining system 20, in accordance with the present invention, further includes a stereo-vision assembly 60. The stereo-vision assembly 60 includes stereo-cameras 62 preferably mounted to the headliner 64 of the vehicle 26. The stereo-vision assembly 60 includes a first camera 70 and a second camera 72, both connected to a camera controller 80. In accordance with one exemplary embodiment of the present invention, the cameras 70, 72 are spaced apart by approximately 35 millimeters (“mm”), although other spacing can be used. The cameras 70, 72 are positioned in parallel with the front-to-rear axis of the vehicle, although other orientations are possible.

The camera controller 80 can take any of several forms such as a microcomputer, discrete circuitry, ASIC, etc. The camera controller 80 is connected to the air bag controller 50 and provides a signal to the air bag controller 50 to provide data relating to various characteristics of the occupant. The air bag control algorithm associated with the controller 50 can be made sensitive to the provided data. For example, if the provided data indicates that the occupant 40 is an object, such as a shopping bag, and not a human being, actuating the air bag serves no purpose. Accordingly, the air bag controller 50 can include a pattern recognition classifier 54 operative to distinguish between a plurality of occupant classes based on the data provided by the camera controller.

Referring to FIG. 2, the cameras 70, 72 may be of any several known types. In accordance with one exemplary embodiment, the cameras 70, 72 are charge-coupled devices (“CCD”) or complementary metal-oxide semiconductor (“CMOS”) devices. The output of the two devices can be combined to provide three-dimension information about an imaged subject 94 as a stereo disparity map. Since the cameras are at different viewpoints, each camera sees the subject at different position. The image difference is referred to as “disparity.” To get a proper disparity determination, it is desirable for the cameras to be positioned and set up so that the subject 94 to be monitored is within the horopter of the cameras.

The subject 94 is viewed by the two cameras 70, 72. Since the cameras 70, 72 view the subject 94 from different viewpoints, two different images are formed on the associated pixel arrays 110, 112, of cameras 70, 72 respectively. The distance between the viewpoints or camera lenses 100, 102 is designated “b”. The focal length of the lenses 100 and 102 of the cameras 70 and 72 respectively, is designated as “f”. The horizontal distance from the image center on the CCD or CMOS pixel array 110 and a given pixel representing a portion of the subject 94 on the pixel array 110 of camera 70 is designated “dl” (for the left image distance). The horizontal distance from the image center on the CCD or CMOS pixel array 112 and a given pixel representing a portion of the subject 94 on the pixel array 112 for the camera 72 is designated “dr” (for the right image distance). Preferably, the cameras 70, 72 are mounted so that they are in the same image plane. The difference between dl and dr is referred to as the image disparity. The analysis can be performed pixel by pixel for the two pixel arrays 110, 112 to generate a stereo disparity map of the imaged subject 94, wherein a given point on the subject 94 can be represented by x and y coordinates associated with the pixel arrays and an associated disparity value.

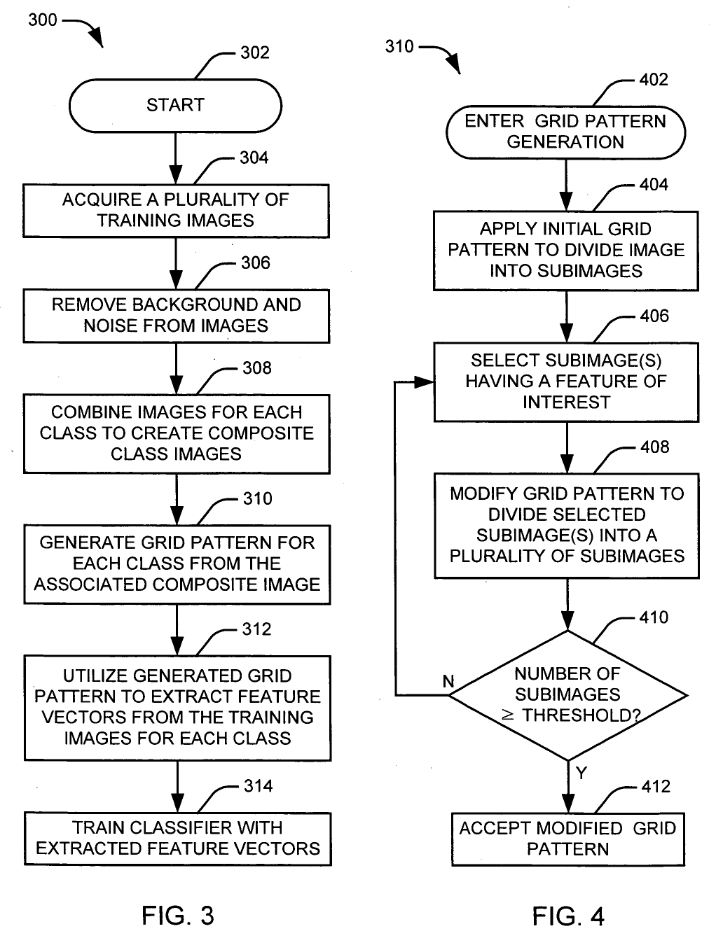

Referring to FIG. 3, a training process 300 for the pattern recognition classifier 54, in accordance with one exemplary embodiment of the present invention, is shown. Although serial and parallel processing is shown, the flow chart is given for explanation purposes only and the order of the steps and the type of processing can vary from that shown. The training process is initialized at step 302, in which internal memories are cleared, initial flag conditions are set, etc. At step 304, a plurality of training images are acquired. The acquired images represent one or more desired output classes, with each class associated with a subset of the plurality of training images. The number of images required for training will vary with the specific application, the number of classes, and the nature of the pattern recognition classifier.

For two-dimensional applications, the images can be acquired using known digital imaging techniques. Three-dimensional image data can be provided via the stereo camera 62 as a stereo disparity map. The Otsu algorithm [Nobuyuki Otsu, “A Threshold Selection Method from Gray-Level Histograms,” IEEE Transactions on Systems, Man, and Cybernetics, Vol. 9, No. 1, pp. 62-66, 1979] can be used to obtain a binary image of an object with the assumption that a given subject of interest is close to the camera system. The stereo images are processed in pairs and the disparity map is calculated to derive 3D information about the image.

Background information and noise are removed from the acquired images in step 306. The image can also be processed to better emphasize desired image features and maximize the contrast between structures in the image. For example, a contrast limited adaptive histogram equalization (CLAHE) process can be applied to adjust the image for lighting conditions based on an adaptive equalization algorithm. The CLAHE process lessens the influence of saturation resulting from direct sunlight and low contrast dark regions caused by insufficient lighting. The CLAHE process subdivides the image into contextual regions and applies a histogram-based equalization to each region. The equalization process distributes the grayscale values in each region across a wider range to accentuate the contrast between structures within the region. This can make otherwise hidden features of the image more visible.

The subset of images representing each output class is then combined into a class composite image at step 308. The class composite image provides an overall representation of one or more features across the subset, such as brightness, hue, saturation, coarseness, and contrast. For a set of grayscale images, for example, the class feature image can be formed according to a pixel-by-pixel averaging of brightness across the subset of images.

A grid generation algorithm is applied to the class composite image at step 310 to generate a representative grid pattern for the class. The representative grid pattern is generated so as to divide the class composite image into a plurality of sub-images according to one or more attributes of interest. The grid generation algorithm iteratively modifies an initial grid pattern according to the distribution of desired feature information within the image. For example, the grid generation algorithm can select an existing sub-image within the class composite image that has a maximum associated value for a particular feature, such as coarseness, average pixel brightness, or contrast. The class representative grid pattern is then modified to segment the selected sub-image into a plurality of new sub-images. The process continues until a grid pattern creating a threshold number of sub-images is created.

At step 312, the generated class representative grid for each class is utilized to extract training data, in the form of feature vectors, from the subset of training images associated with the class. A feature vector contains a plurality of elements representing an image. Each element can assume a value corresponding to a quantifiable image feature. The grid representing a given class can be applied to one of its associated training images to divide the image into a plurality of sub-images. Each sub-image contributes one or more values for elements within a feature vector representing the training image. The contributed values are derived from the sub-image for one or more attributes of interest. The attributes of interest can include the average brightness of the sub-image, the variance of the grayscale values of the pixels comprising the sub-image, a coarseness measure of the sub-image, or other similar measures.

Once feature vectors have been extracted from the plurality of training images, the pattern recognition classifier is trained with the extracted feature vectors at step 314. The training process of the pattern recognition classifier will vary with the implementation of the classifier, but the training generally involves a statistical aggregation of the feature vectors into one or more parameters associated with the output class. For example, a pattern recognition processor implemented as a support vector machine can process the feature vectors to produce functions representing boundaries in a feature space defined by the various attributes of interest. The bounded region for each class defines a range of feature values associated with the class.

The grid generation algorithm 310 will be appreciated in an expanded form with respect to FIG. 4. Although serial and parallel processing is shown, the flow chart is given for explanation purposes only and the order of the steps and the type of processing can vary from that shown. The grid generation algorithm is applied to a composite class image, representing an output class of a classifier, in step 402. It will be appreciated that the composite class image can be a 2D gray scale image, 2D color image, or a 3D image, such as a stereo disparity map. The image region defines an image frame along its borders.

At step 404, an initial grid pattern is applied to the image frame. The initial grid pattern divides the image into a plurality of sub-images in a predetermined fashion. The form of the initial grid pattern will vary with the form of the composite class image and the application. For example, a two-dimensional grid pattern can comprise one or more intersecting lines and curves, shaped to fit the image frame. A three-dimensional grid pattern can comprise a one or more intersecting planes and curved surfaces, arranged to provide sub-image regions. It will be appreciated that the grid pattern is not a tangible alteration to the image, but rather an abstract representation of a division of the image into desirable sub-images. For the purpose of discussion, however, it is instructive to discuss the lines and planes composing the grid pattern as tangible entities and illustrate them accordingly.

In an exemplary embodiment, the initial grid pattern is applied to divide the composite image into sub-images of the same general size and shape. For example, it the original image is a two-dimensional square, the initial grid pattern can be divided into 2^{2N} squares of equal size by (4N−2) intersecting lines, where N is a positive integer. Similarly, a two-dimensional circular region can be divided into a plurality of equal size wedge-shapes regions via one or more evenly spaced lines drawn through a center point of the circular region. One skilled in the art will appreciate additional methods of determining an initial grid for various applications from the description herein.

At step 406, the sub-images are evaluated for one or more attributes of interest, and any sub-images containing the desired attributes are selected. For example, an attribute of interest can be a variance in the grayscale values of the pixels that meets a certain threshold value. In an exemplary embodiment, the sub-images are evaluated to determine a sub-image that contains a maximum value for an attribute of interest, such that one sub-image is selected for each evaluation. For example, a sub-image having a maximum average brightness over its constituent pixels can be selected. It will be appreciated that the attributes of interest can vary with the nature of the image. Exemplary attributes of interest can include an average or variance measure of the color saturation of a sub-image, a coarseness measure of the sub-image coarseness, an average or variance measure of the hue of the sub-image, and an average or variance of the brightness of the sub-image.

At step 408, the grid pattern is modified to divide the selected one or more sub-images into respective pluralities of sub-images. A selected sub-image can be divided by adding one or more line segments to the grid pattern to separate the sub-image into two or more new sub-images. In an exemplary embodiment, the selected sub-images are divided as to produce sub-images of the same general shape. For example, if the initial grid pattern separates the image into square sub-images, the grid pattern can be modified such that a selected sub-image is separated into a plurality of smaller squares.

At step 410, it is determined if the modified grid divides the image into a threshold number of sub-images. If the number of sub-images is less than the threshold, the method returns to step 406 to select an additional one or more sub-images to be further divided. During the new iteration of the algorithm, all of the sub-images created during the previous iteration are evaluated for selection according to their associated values of the attribute of interest. If the number of sub-images exceeds the threshold, the method advances to step 412, where the modified grid pattern is accepted as a representative grid pattern for the output class. The class representaive grid pattern can then be utilized in extracting feature data from the training images associated with the class.

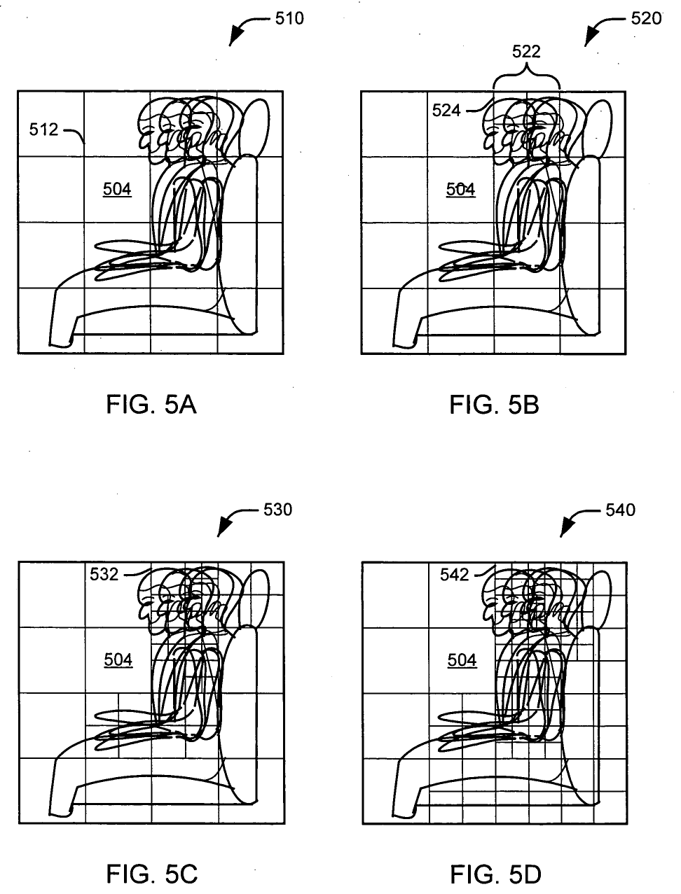

FIGS. 5A-5D illustrate the progression of an exemplary grid generation algorithm applied to a composite image 504. The composite image 504 is a simplified representation of a class composite image that could be acquired in a vehicle safety control application. The illustrated class composite image 504 represents a class of full-sized adult passengers, and can be derived from a plurality of images of adult passengers. It will be appreciated that more complicated images will generally be acquired in practice. For example, the class composite image used in the grid generation algorithm can be generated as a combination of a large number of training images (e.g., between one thousand and ten-thousand images). Such a composite image is unlikely in practice to provide a clear, definite image of the imaged object as is illustrated in FIGS. 5A-5D.

In the exemplary algorithm, each square sub-image is divided into four square sub-images of equal size until a threshold of one hundred sub-images is reached. The attribute of interest for the exemplary algorithm is a maximum contrast value. The algorithm is illustrated as a series of four stages 510, 520, 530, and 540, with each stage representing a selected point in the algorithm. It will be appreciated that several iterations of the algorithm can occur between illustrated stages and that the number of iterations occurring between the stages is not constant.

In FIG. 5A, a first stage 510 of the exemplary grid generation algorithm is illustrated. In the first stage 510, an initial grid pattern 512 is imposed over the class composite image 504. The initial grid pattern 512 divides the image into sixteen square sub-images of equal size. It will be appreciated that the initial grid pattern is applied to the image in the same manner regardless of any attributes of the image.

At FIG. 5B, a second stage 520 of the exemplary grid generation algorithm is illustrated. At the second stage, a sub-image 522 has been selected as having a maximum associated amount of contrast in comparison to the other fifteen sub-images formed by the initial grid, in accordance with the exemplary algorithm. The initial grid pattern is modified to divide the selected sub-image 522 into four additional sub-images, such that the modified grid pattern 524 divides the image into nineteen sub-images. As the algorithm continues, each of these sub-images will be evaluated along with the original sixteen sub-images in selecting a sub-image with optimal contrast.

FIG. 5C illustrates a third stage 530 of the exemplary grid generation algorithm. At the third stage 530, the algorithm has proceeded through ten additional iterations, such that the modified grid pattern 532 divides the image into forty-nine sub-images. At this stage 530, the modified grid algorithm has already begun to emphasize regions of high contrast within the image 504 and deemphasize regions of low contrast within the image 504. For example, the four sub-images created from the initial grid pattern that comprise the upper left corner of the image contain no contrast. Accordingly, the four sub-images have not been further divided, which minimizes their impact upon the feature data extracted from the image. The upper right corner, however, contains a significant amount of contrast and has been subdivided extensively under the algorithm.

FIG. 5D illustrates a fourth stage 540 of the exemplary grid generation algorithm. At the fourth stage 540, the modified grid pattern has reached one-hundred sub-images, completing the exemplary grid generation algorithm. The completed grid pattern 542 contains a large number of sub-images around the high contrast portions of the image 504, such as the head and torso of the occupant, and significantly fewer sub-images within the low contrast portions of the image. Accordingly, the completed grid 542 selectively emphasizes data found within high contrast regions associated with the class composite image when utilized to extract feature data from training images.

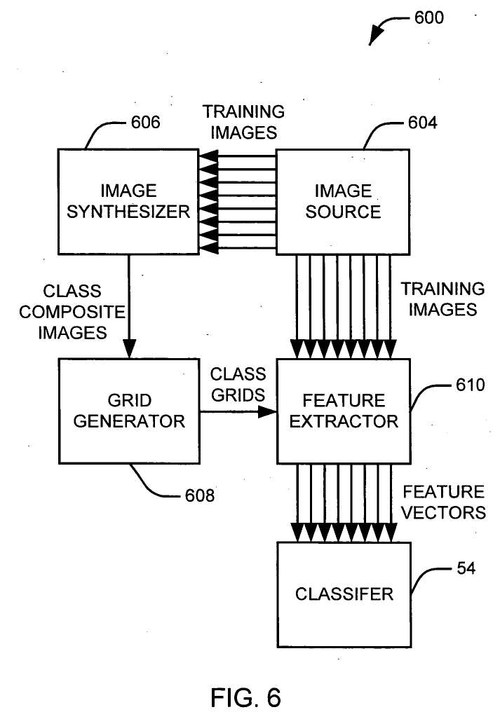

Referring to FIG. 6, the classifier training process will be better appreciated. A training system 600 in accordance with an exemplary embodiment of the present invention can be utilized to train a classifier 54 associated with a vehicle safety device control system, such as the actuatable occupant restraint system 20 illustrated in FIG. 1. For example, the classifier 54 can be used to determine an associated class from a plurality of classes (e.g., adult, child, rearward facing infant seat, etc.) for the occupant of a passenger seat of an automobile to control the deployment of an air bag associated with the seat. Similarly, the classifier 54 can be used to facilitate the identification of an occupant's head by determining if a candidate object resembles a human head. It will be appreciated that the classifier training system 600 can be implemented, at least in part, as computer software operating on a general purpose computer.

The classifier 54 can be implemented as any of a number of intelligent systems suitable for classifying an input image. In an exemplary embodiment, the classifier 54 can utilize one of a Support Vector Machine (“SVM”) algorithm or an artificial neural network (“ANN”) learning algorithm to classify the image into one of a plurality of output classes. It will be appreciated that the classifier 54 can comprise a plurality of individual classification systems united by an arbitration system that selects between or combines their outputs.

An image source 604 can be used to acquire a plurality of training images. The image source 604, for example, can comprise one or more digital cameras that image a plurality of subjects of interest to produce training images. In an exemplary embodiment, the image source can comprise a stereo camera, such as that illustrated in FIG. 2. For a vehicle safety system application, the training images can be associated with classes representing potential occupants of a passenger seat, such as a child class, an adult class, a rearward facing infant seat class, an empty seat class, and similar useful classes.

For example, the adult class can be represented by images taken of a number (e.g., 100) of adult subjects. The adult subjects can be selected to have physical characteristics (e.g., height, weight) that vary across an expected range of characteristics for human adults. A training image can be taken of each subject in a variety of different positions that might reasonably be assumed in an automobile seat. For example, one or more images can be acquired while the subject is leaning to one side, bending forward to retrieve something from the floor, or reclining in the seat, along with images of the occupant in a normal upright position. The sets of images taken of each subject collectively form a training set for the adult class. This process can be repeated for the other classes to obtain training data for those classes. For example, images can be taken of a plurality of different rearward facing infant seats in a plurality of possible positions.

The image source 604 can include preprocessing capabilities to improve the resolution and visibility of the training images. For example, a contrast limited adaptive histogram equalization can be applied to adjust the image for lighting conditions. The equalization eliminates saturated regions and dark regions caused by non-ideal lighting conditions. The image can be equalized at each of a plurality of determined low contrast regions to distribute a relatively narrow range of grayscale values within each region across a wider range of values. This can eliminate regions of limited contrast (e.g., regions of saturation or low illumination) and reveal otherwise indiscernible structures within the low contrast regions.

The training images for each class are provided to an image synthesizer 606. The image synthesizer 606 combines the plurality of training images for each class to produce a class composite image. The images can be combined in a number of ways, depending on the desired application. For example, in an application utilizing grayscale images, the composite image can be formed by a pixel-by-pixel averaging across the images of a grayscale value, or brightness, at corresponding pixels. Depending on the desired application, the class composite image can represent a composite of the training images across any of a number of image attributes, such as brightness, color saturation, hue, contrast, or texture.

The class composite images are then provided to a grid generator 608 that produces a representative class grid pattern from each class composite image according to a grid generation algorithm. The grid generator 608 determines regions of the class composite images of particular importance in discriminating images of their associated classes. For example, the grid generator 608 can emphasize regions of the image containing desirable values of a particular attribute of interest.

A given class grid pattern comprises a plurality of separator elements that can be applied to an image to generate a plurality of sub-images. Regions of interest to a particular class are indicated within its associated class grid pattern by an increased density of separator elements at the regions of interest. Accordingly, when the class grid image is applied to an image, an increased number of sub-images will be generated in the regions of interest.

The class grid patterns are provided to a feature extractor 610 that reduces the training images for each class to feature vectors according to the grid pattern associated with the class. A feature vector represents an image as a plurality of elements, where each element represents an image feature. The grid pattern is used to define a plurality of sub-images within each training image, with each sub-image contributing an equal number of elements to the feature vector according to one or more attributes of the sub-image. Exemplary attributes can include an average or variance measure of the color saturation of a sub-image, a coarseness measure of the sub-image coarseness, an average or variance measure of the hue of the sub-image, and an average or variance of the brightness of the sub-image.

In an exemplary embodiment, the following attributes are extracted from each sub-image:
1) Average grayscale intensity:

$$\overline{I} = \frac{{\sum }_{i = 1}^{n} {I}_{i}}{n}$$
2) Variance of grayscale intensity values:

$$σ = \sqrt{\frac{{\sum }_{i = 1}^{n} {( {I}_{i} - \overline{I} )}^{2}}{n - 1}}$$
3) Coarseness:

$$Co = {\sum }_{( x , y ) ∈ Region} C ( x , y )$$

The coarseness measure represents an average size of homogenous regions within a sub-image (e.g., regions of pixels approximately the same grayscale value), and provides a texture measure for the sub-image.

The extracted feature vectors are then provided to the classifier 54 as training data. The training process of the classifier 54 will vary with its implementation. For example, an exemplary ANN classifier can be provided with each training sample and its associated class as training samples. The ANN calculates weights associated with a plurality of connections (e.g., via back propagation or a similar training technique) within the network based on the provided data. The weights bias the connections within network such that later inputs resembling the training inputs for a given class will produce an output representing the class.

Similarly, a SVM classifier can analyze the feature vectors with respect to an N-dimensional feature space to determine regions of feature space associated with each class. Each of the N dimensions represents one associated feature of the feature vector. The SVM produces functions, referred to as hyperplanes, representing boundaries in the N-dimensional feature space. The boundaries define a range of feature values associated with each class, and future inputs can be classified according to their position with respect to the boundaries.

From the above description of the invention, those skilled in the art will perceive improvements, changes and modifications. Such improvements, changes and modifications within the skill of the art are intended to be covered by the appended claims.

1. A system for selectively generating training data for a pattern recognition classifier from a plurality of training images representing an output class, said system comprising:
an image synthesizer that combines the plurality of training images into a class composite image;
a grid generator that generates a grid pattern representing the output class from the class composite image; and
a feature extractor that extracts feature data from the plurality of training images according to the generated grid pattern.

2. The system of claim 1 wherein the grid generator generates the grid pattern according to at least one attribute of interest associated with the class composite image.

3. The system of claim 1 wherein the grid pattern divides the class composite image into a plurality of sub-images, the feature extractor extracting data relating to each of the plurality of sub-images.

4. The system of claim 3 wherein the grid generator operates according to a grid generation algorithm to select one of the plurality of sub-images according to an attribute of interest and modifies the grid pattern according to the identified sub-image.

5. The system of claim 4 wherein the attribute of interest is a maximum average grayscale value out of a plurality of average grayscale values associated with respective sub-images.

6. The system of claim 4 wherein the attribute of interest is a maximum grayscale variance out of a plurality of grayscale variances associated with the respective sub-images.

7. The system of claim 4 wherein the grid pattern modifies the grid pattern as to divide the selected sub-image into a plurality of sub-images.

8. The system of claim 7 wherein the grid pattern is iteratively modified until a grid pattern that divides the class composite image into a threshold number of sub-images has been generated.

9. The system of claim 1, further comprising a pattern recognition classifier that is trained using the extracted feature data.

10. The system of claim 9 wherein the pattern recognition classifier includes at least one of a neural network and a support vector machine.

11. The system of claim 1, further comprising an image source that provides the plurality of training images.

12. The system of claim 11 wherein the image source includes a stereo camera.

13. A system for selectively generating training data for a pattern recognition classifier associated with a vehicle occupant safety system comprising:
a vision system that images the interior of a vehicle to provide a plurality of training images representing an output class;
a grid generator that generates a grid pattern representing the output class from a class composite image; and
a feature extractor that extracts training data from the plurality of training images according to the generated grid pattern.

14. The system of claim 13, further comprising an image synthesizer that combines the plurality of training images to provide the class composite image.

15. The system of claim 13 wherein the plurality of training images representing the output class includes images of a human adult seated within the vehicle interior.

16. The system of claim 13 wherein the plurality of training images representing the output class includes images of a rearward facing infant seat positioned within the vehicle interior.

17. The system of claim 13 wherein the plurality of training images representing the output class includes images of a human head.

18. The system of claim 13, the vision system comprising a stereo vision system that produces three-dimension image data of the vehicle interior as a stereo disparity map.

19. A method for selectively generating training data for a pattern recognition classifier from a plurality of training images representing a desired output class, said method comprising the steps of:
generating a representative image that represents the output class;
dividing the representative image according to an initial grid pattern to form a plurality of sub-images;
identifying at least one sub-image formed by said grid pattern having at least one attribute of interest;
modifying said grid pattern in response to the identified at least one sub-image having said at least one attribute of interest so as to form a modified grid pattern; and
using the modified grid pattern to extract respective feature vectors from the plurality of training images.

20. The method of claim 19 wherein the step of generating a representative image includes combining the plurality of training images to form a class representative image.

21. The method of claim 19, where the step of generating a representative image includes averaging grayscale values across corresponding pixels in the plurality of training images.

22. The method of claim 19, wherein the step of modifying the grid pattern includes modifying the grid pattern to divide the identified sub-images into respective pluralities of sub-images.

23. The method of claim 19 wherein the at least one attribute of interest includes an average grayscale value associated with a sub-image that exceeds a threshold value.

24. The method of claim 19 wherein the at least one attribute of interest includes a coarseness measure associated with a sub-image exceeds a threshold value.

25. The method of claim 19 wherein the at least one attribute of interest includes a maximum average grayscale value out of a plurality of average grayscale values associated with respective sub-images.

26. The method of claim 19 wherein the step of using the modified grid pattern to extract respective feature vectors from the plurality of training images includes applying the modified grid to a training image to form a plurality of sub-images from the training image and extracting at least one element associated with a respective feature vector from each of the plurality of sub-images.

27. The method of claim 19 wherein the steps of identifying at least one sub-image and modifying the grid pattern in response to the identified sub-image are repeated iteratively until a termination event is recorded.

28. The method of claim 27 wherein the termination event comprises producing a modified grid that divides the class composite image into a threshold number of sub-images.
